(19) United States
(12) Patent Application Publication
(10) Pub. No.: US 2013/0137094 A1
(43) Pub. Date: May 30, 2013

(54) One-Step Cell and Tissue Preservative for Morphologic and Molecular Analysis

(71) Applicants: Virginia A. Espina, Rockville, MD (US); Lance A. Liotta, Bethesda, MD (US); Claudius Mueller, Gainesville, VA (US)

(72) Inventors: Virginia A. Espina, Rockville, MD (US); Lance A. Liotta, Bethesda, MD (US); Claudius Mueller, Gainesville, VA (US)

(73) Assignee: GEORGE MASON INTELLECTUAL PROPERTIES, INC., Fairfax, VA (US)

(21) Appl. No.: 13/575,001

(22) PCT Filed: Jan. 25, 2011
(86) PCT No.: PCT/US2011/022463

§ 371 Date: Nov. 15, 2012

Related U.S. Application Data
(60) Provisional application No. 61/298,031, filed on Jan. 25, 2010.
(60) Provisional application No. 61/352,580, filed on Jun. 8, 2010.

(51) Int. Cl. G01N 1/30

(52) U.S. Cl. CPC G01N 1/30
USPC 435/6.11; 435/374; 435/23; 435/6.1; 435/7.1; 435/7.9

(57) ABSTRACT

The invention relates to a one-step chemical composition that preserves animal tissue, cells, and biomolecules, such as human tissue, human cells, and biomolecules therein. It improves the fidelity and morphologic structure of cells, organelles, and nuclear chromatin, and maintains and enhances the cellular antigenicity for immunohistochemistry and flow cytometry, while preserving proteins, post-translational modifications of proteins, and nucleic acids. In one embodiment, the composition comprises a) a non-aldehyde precipitating fixative at a concentration below 25% (volume/volume), b) a reversible/cleavable protein cross-linker that targets lipid-associated molecules, and c) a c reversible/cleavable protein cross-linker that targets water soluble molecules. In another embodiment, the composition further includes a kinase inhibitor, a phosphatase inhibitor, and a permeation enhancer. In still another embodiment, the compositions further include lactic acid at a concentration sufficient to maintain cellular nuclear volume at a level equivalent to aldehyde fixation of the same type of cell. In a further embodiment, the composition comprises: a) a precipitating fixative, b) a reversible/cleavable cross-linker, c) a permeation enhancer, d) a kinase inhibitor, e) a phosphatase inhibitor, and f) a carboxylic acid. In a still further embodiment, the invention comprises method for preserving a biological sample by contacting the sample with the composition of the invention under conditions effective for the preservation of the sample.

### CROSS-REFERENCE TO RELATED PATENT APPLICATIONS

This application claims the benefit of the filing date of U.S. Provisional Patent Application No. 61/298,031, filed Jan. 25, 2010, and U.S. Provisional Patent Application No. 61/352,580, filed Jun. 8, 2010, the disclosures of which are expressly incorporated herein by reference in their entireties. This application is a continuation-in-part of, and claims the benefit of, U.S. patent application Ser. No. 12/447,773, filed Oct. 26, 2007, which is a national phase application of PCT/US2007/022744, filed Oct. 26, 2007, the disclosures of which are expressly incorporated herein by reference in their entireties. The disclosures of U.S. Provisional Patent Application No. 61/048,601, filed Apr. 29, 2008, and U.S. Provisional Patent Application No. 61/218,132, filed Jun. 18, 2009, are expressly incorporated herein by reference in their entireties.

### FIELD OF THE INVENTION

The invention relates to chemical compositions that preserve animal tissue, cells, and biomolecules. More particularly, it relates to a one-step chemical composition that: a) improves the fidelity and morphologic structure of cells, organelles, and nuclear chromatin, and b) maintains and enhances the cellular antigenicity for immunohistochemistry and flow cytometry, and flow sorting while preserving proteins, post-translational modifications of proteins, and nucleic acids.

### BACKGROUND

Traditional fixatives for cells and tissue employ ethanol at high concentrations to precipitate proteins, or utilize aldehyde chemistries, such as formalin, to generate fixation by forming permanent cross-links. Ethanol or methanol fixation is suitable for some aspects of tissue fixation requiring preservation of macromolecules, but it is less desirable for preservation of histomorphology because it removes water and shrinks the cells, distorting morphology and reducing the microscopic detail of the nuclear chromatin and cytoplasm. This deficiency is particularly true for the use of ethanol fixatives for suspended blood cells. On the other hand, aldehyde fixatives preserve cell morphology for cytologic diagnosis, but the cross-links they generate greatly hinder the extractability of molecules for diagnosis and limit the size and quality of preservation of nucleic acid molecules that can be extracted for genomic testing. Fresh frozen cells preserve macromolecules without cross-links and maximize extractability of molecules, but frozen tissue is not suitable for routine histologic diagnosis because freezing distorts and blurs the morphology of cells and extracellular elements.

Because of the limitations of these fixative approaches, tissue or cell samples are commonly divided up and preserved by different methods for different downstream analysis. For example, one portion of the tissue is placed in formalin for diagnosis and immunohistology, another piece is frozen and stored for protein analysis, and another is placed in a nucleic acid preservative. Beyond the cost and extra labor, the disadvantage is that diagnostic information, such as a region of cancer, may be heterogeneously distributed among the separate tissue portions placed in different preservatives. This could cause a critical diagnosis to be missed or an analysis done on one piece of tissue to be unrelated to the disease being treated. The present invention provides a one step preservation composition that preserves all major classes of diagnostic molecules, rendering them easy to extract, while preserving cytology and histomorphology for routine diagnostic analysis of blood cells, body fluid cells, and tissue.

### BRIEF DESCRIPTION OF THE FIGURES

FIG. 1: Example of representative tissue histomorphology following paraffin embedding using the preservation chemistry of the subject invention, compared to formalin fixed paraffin embedded tissue (FFPE). Preservation of cytologic detail, nuclear detail, cytoplasmic detail, and tissue architecture, for the indicated tissues, is equal or superior to formalin. Hematoxylin and Eosin stain.

FIG. 2: Preservation of nuclear volume by the subject invention compared to formalin fixed tissue. The indicated tissues and the indicated number of nuclei were quantified. Nuclear volume by the subject invention (BHP) is equal or superior to formalin (FFPE).

FIG. 3: Preservation of nuclear chromatin in meiotic cells in feline testes. Hematoxylin and Eosin stain. Chromatin structure, fidelity and detail, using the subject invention (left) is superior to formalin (right).

FIG. 4: Preservation of bone and bone marrow histomorphology using the subject invention as a one step treatment prior to paraffin embedding. Bone marrow cell nuclear and cytoplasmic detail, including megakaryocytes, are well preserved. Hematoxylin and Eosin stain.

FIG. 5: Preservation of DNA for high resolution SNP copy number variation analysis by one step fixation of bone marrow aspirate cells using subject invention, compared to unfixed. Retention of SNP hybridization and copy number amplitude is identical between fixed and fresh samples across all chromosomes.

FIG. 6: Preservation of flow cytometry parameters: separation of blood immune cell populations is retained following 1 or 24 hours of fixation in the subject invention equivalent to unfixed cells. Preservation of immune cell cytomorphology is equivalent across the white cell subtypes.

FIG. 7: Quantitative preservation of flow cytometry blood cell surface antigens over time in the subject invention for the indicated antigen and the indicated time.

FIG. 8: Extraction yield of total protein from paraffin embedded tissue fixed in the subject invention (BHP-tissue) or formalin (NBF) compared to frozen tissue. Virtually one hundred percent extraction can be achieved in less than 10 minutes (Upper panel), while one hour is required for extraction using harsh extraction methods from formalin-fixed tissue (Lower panel).

FIG. 9: Preservation of example labile phosphoproteins at 1 and 7 days following fixation and paraffin embedding of colonic mucosa in the subject invention. Each symbol represents a different region of colonic mucosa. The phosphoprotein antigen measured by reverse phase protein microarrays is indicated. No significant difference in the average level was noted over time zero (horizontal line), day 1 and day 7, verifying stabilization of tissue phosphoproteins in the subject invention fixative prior to paraffin embedding.

FIG. 10: Preservation of RNA in the subject invention chemistry over a 72 hour period. The RNA integrity number (RIN) is shown for time zero compared to the subject invention or a commercially available, room temperature RNA preservative, “RNAlater®”. Equivalent preservation between the two fixatives is noted over a 72 hour period (subject invention at 4 degrees C.).

FIG. 11: One-step workflow for tissue or cell preservation for downstream analysis.

### DESCRIPTION OF THE INVENTION

The invention relates to a one-step chemical composition that preserves animal tissue, cells, and biomolecules, such as human tissue, human cells, and biomolecules therein. It improves the fidelity and morphologic structure of cells, organelles, and nuclear chromatin, and maintains and enhances the cellular antigenicity for immunohistochemistry and flow cytometry, while preserving proteins, post translational modifications of proteins, and nucleic acids.

As used herein, the term “animal” is any organism of the kingdom Animalia. In one aspect, the animal is a vertebrate. In a more particular aspect, the animal is a mammal. The mammal may be any mammal, including but not limited to humans, other primates, pets, such as dogs and cats, farm animals, and laboratory animals, such as monkeys, rats, mice, rabbits, guinea pigs, dogs, and cats.

In one embodiment, the composition comprises a) a non-aldehyde precipitating fixative at a concentration below 25% (volume/volume), b) a cleavable protein cross-linker that targets lipid-associated molecules, and c) a cleavable protein cross-linker that targets water soluble molecules. In one aspect of this embodiment, the fixative is ethanol or methanol, the cleavable protein cross-linker that targets lipid-associated molecules is dithiobis[succinimidylpropionate] (DSP), and the cleavable protein cross-linker that targets water soluble molecules is disuccinimidyl tartarate (DST) or dimethyl 3,3′-dithiobispropionimidate2HCl (DTBP).

In another embodiment, the composition further includes a kinase inhibitor, a phosphatase inhibitor, and a permeation enhancer. In one aspect, the permeation enhancer is polyethylene glycol, the kinase inhibitor is selected from one of more types of kinase inhibitors such as non-hydrolysable ATP, genistein, small molecule kinase inhibitors (wortmanin), antibody, aptamer, or staurosporine, and the phosphatase inhibitor is sodium orthovanadate, β-glycerophosphate, sodium fluoride, or sodium molybdate. In still another embodiment, the compositions further include lactic acid at a concentration sufficient to maintain cellular nuclear volume at a level equivalent to aldehyde fixation of the same type of cell. The lactic acid also decalcifies boney elements and calcium precipitate in the tissue and cells, maintains cellular morphology, nuclear volume, and nuclear chromatin at a level equivalent or superior to aldehyde fixation, and maintains the antigenic preservation of nuclear, membrane, and cytoplasmic antigens equivalent to aldehyde fixation. In one aspect of this embodiment, the concentration of lactic acid is greater than 5% (weight/volume). The composition is used to preserve suspended cells for flow cytometry analysis, preserve cellular DNA for genetic analysis, such as SNP analysis, and preserve RNA for at least 72 hours at four degrees C. The composition is compatible with paraffin embedding and supports sufficient stabilization of post-translationally modified molecules, nucleic acids, cellular morphology, and cellular antigens for diagnostic purposes.

In one particular embodiment, the composition comprises: a) a precipitating fixative, b) a reversible or cleavable protein cross-linker, c) a permeation enhancer, d) a kinase inhibitor, e) a phosphatase inhibitor, and f) a carboxylic acid. In a more particular embodiment, it also includes an isotonic salt solution.

The precipitating fixative is any chemical that stabilizes the proteins in the sample and has a sufficient water content for a permeation enhancer, a kinase inhibitor, and/or a phosphatase inhibitor to be soluble therein. In one aspect, it is an alcohol, such as methanol or ethanol. In a preferred aspect, it is ethanol.

The reversible or cleavable protein cross-linker (hereinafter “reversible/cleavable cross-linker”) can be hydrophobic or hydrophilic. It can be a molecule that targets lipid-associated molecules, such as dithiobis[succinimidylpropionate], or it can be a molecule that targets water soluble molecules, such as disuccinimidyl tartarate or dimethyl 3,3′-dithiobispropionimidate2HCl.

The permeation enhancer can be a polymer or a nanoparticle. In one aspect, it is water, dimethylsulfoxide, polyethylene glycol, or propylene glycol. In a preferred aspect, it is polyethylene glycol.

The kinase inhibitor is any one compatible with the composition of the invention and its intended uses. In one aspect, it is staurosporine, genistein, or non-hydrolysable ATP. In a preferred aspect, it is staurosporine and genistein together.

The phosphatase inhibitor is any one compatible with the composition of the invention and its intended uses. In one aspect, it is sodium orthovanadate or beta glycerophosphate. In a preferred aspect, it is sodium orthovanadate and beta glycerophosphate together.

The lactic acid is present in the composition at about 5% (w/v) to about 12% (w/v) of the solution. In a preferred aspect, it is present at about 10% of the solution. In another preferred aspect, the lactic acid is L(+) lactic acid.

The isotonic salt solution is any one compatible with the composition of the invention and its intended uses. In one aspect, it is Hank's Balanced Salt Solution. In a particular aspect, the Hank's Balanced Salt Solution is present at a concentration of about 40% to about 80% and preferably at about 68% to about 76%.

In one preferred aspect of the invention, the composition comprises ethanol at a concentration less than about 25%, polyethylene glycol at a concentration between about 1% and about 0.01%, staurosporine and genistein at concentrations between about 1 mM and about 1 μM, sodium orthovanadate and beta glycerophosphate at concentrations between about 1 mM and about 500 mM, dithiobis[uccinimidylpropionate] and dimethyl 3,3′-dithiobispropionimidate2HCl at concentrations between about 1 g/ml and about 0.5 mg/ml, and lactic acid at a concentration of about 5% (w/v) to about 12% (w/v) of the solution. In a still further embodiment, the invention comprises a method for preserving a biological sample by contacting the sample with the composition of the invention under conditions effective for the preservation of the sample. Such conditions are readily determinable by persons skilled in the art, given the teachings contained herein. The sample may comprise animal tissue, cells, and/or biomolecules. In a preferred aspect, the sample is from a human. The method stabilizes chromatin and nucleic acids, such as DNA, RNA, and miRNA, in the cells in the sample. It preserves DNA and RNA modifications. It stabilizes proteins, phosphoproteins, and protein posttranslational modifications in the sample. It preserves tissue microstructure and cellular morphology, including the morphology of the nucleus, cytoplasm, and organelles in the cytoplasm. It preserves immunohistochemistry markers in the sample, such as estrogen receptor alpha, progesterone receptor, Her2, and Ki-67. It preserves biometal pools. In one aspect, it preserves white blood cells in the sample and facilitates their isolation from non-coagulated whole blood in the sample.

The following examples illustrate certain aspects of the invention and should not be construed as limiting the scope thereof.

### EXAMPLES

Two embodiments of the composition of the invention have been tested using clinical samples. One embodiment is optimized for blood cells or exfoliated cells or frozen sections (embodiment 1), while a second embodiment (embodiment 2) is optimized for tissue paraffin embedding. Both embodiments contain ingredients to preserve cell and nuclear structure without requiring aldehyde cross-links and without requiring high concentrations of alcohols that can dehydrate and shrink cell morphology. Embodiment 1, optimized for blood cells, contains two classes of reversible/cleavable cross-linkers that generate excellent preservation of membrane and cytoplasmic detail. This formulation works well for one-step preservation of core needle biopsies for transport without freezing, and the preservation of blood cell morphology for flow cytometry and cell sorting. Embodiment 2 is optimized for whole tissue that is being paraffin embedded for pathologic diagnosis or immunohistochemistry.

The difference between the two embodiments is the addition of lactic acid to the formulation in embodiment 2. Lactic acid above a concentration of 5% (w/v) is found to preserve nuclear volume, nuclear chromatin, cytoplasmic detail and color, immunohistochemistry antigenicity, and to decalcify boney elements, all in one step. Evaluation of several types of carboxylic acids, including acetic acid, revealed that lactic acid above a certain concentration has an unexpected ability to preserve nuclear chromatin, nuclear and cytoplasmic volume, and nuclear membrane structure of cells, while stabilizing antigens for immunohistochemistry, such as estrogen receptor, known to be poorly preserved by alcohol based fixatives. Lactic acid was found significantly superior to acetic acid for morphologic and antigen preservation as well as decalcification. Embodiment 2, containing lactic acid, has been evaluated across all major tissues and all major diagnostic immunohistochemistry antigens found in the nucleus, the cytoplasm, the cell membrane, or the extracellular space. Both embodiments contain kinase and phosphatase inhibitors useful for stabilizing phosphoproteins, and polyethylene glycol as a permeation enhancer, as shown in Espina et al.[1].

The crosslinking chemistries for cells and tissues described herein are readily reversible by reducing agents known in the art, such as disulfide bond breaking reagents. Thus, protein and nucleic acid extraction can be efficiently completed using standard extraction buffers, yielding the potential for one hundred percent extraction efficiency in less than fifteen minutes, using a paraffin embedded section. This is compared to hours or days, and multiple steps, required for extraction of molecules for paraffin embedded sections using fixatives in the prior art.

Two classes of reversible cross linking agents are employed. One class penetrates lipid membranes, and the other is water soluble. It has been found that use of only one cross-linking agent that is either hydrophobic or hydrophilic is suboptimal because it is desirable that both hydrophobic and hydrophilic structures be preserved. Many types of chemical cross-linking agents are commercially available that differ in their targets, their spacer arms, and their means of cleavage (Pierce Inc.). We have found that a combination of cross-linking agents that generate cleavable disulfide bonds are suitable for tissue and cell preservation, while having the advantage of ease of cleavage with reducing agents.

There are a variety of cleavable or non-cleavable cross-linking agents known in the art that can act at neutral or acid pH to achieve the aims of the invention. Suitable chemistries for cell morphology preservation can include a mixture of cleavable and non-cleavable cross-linking agents that act at different pHs, act on different molecules, or penetrate membranes or intracellular and extracellular spaces.

Dithiobis (succinimidyl propionate) (DSP) is a homobifunctional, thiol-cleavable and membrane-permeable cross-linker. It is rapidly cleaved by reducing agents. It contains an amine-reactive N-hydroxysuccinimide (NHS) ester at each end of an 8-carbon spacer arm. NHS esters react with primary amines to form stable amide bonds, along with release of the N-hydroxy-succinimide leaving group. Proteins generally have several primary amines in the side chain of lysine (K) residues and the N-terminus of each polypeptide that are available as targets for NHS-ester cross-linking The disulfide bond in the spacer arm is readily cleaved by 10-50 mM DTT or TCEP at pH 8.5. The spacer arm is also cleaved with 5% β-mercaptoethanol in SDS-PAGE sample loading buffer at 100° C. for 5 minutes.

A carbodiimide (EDC) is a cross-linker that facilitates the direct conjugation of carboxyls to primary amines. Thus, unlike other reagents, EDC is a zero-length cross-linker; it does not become part of the final crosslink between molecules. Because peptides and proteins contain multiple carboxyls and amines, direct EDC-mediated cross-linking usually causes random polymerization of polypeptides. EDC reacts with carboxylic acid groups to form an active O-acylisourea intermediate that is easily displaced by nucleophilic attack from primary amino group in the reaction mixture. The primary amine forms an amide bond with the original carboxyl group, and an EDC by-product is released as a soluble urea derivative. EDC cross-linking is most efficient in acidic (pH 4.5) conditions and must be performed in conditions devoid of extraneous carboxyls and amines. MES buffer (4-morpholinoethanesulfonic acid) is a suitable carbodiimide reaction buffer. Phosphate buffers and higher pH (up to 7.2) conditions are compatible with the reaction chemistry, albeit with lower efficiency; increasing the amount of EDC can compensate for the reduced efficiency.

Pyridyl disulfides react with sulfhydryl groups over a broad pH range (the optimum is pH 4-5) to form disulfide bonds. As such, conjugates prepared using these cross-linkers are cleavable with typical disulfide reducing agents, such as dithiothreitol (DTT). During the reaction, a disulfide exchange occurs between the molecule's —SH group and the 2-pyridyldithiol group. As a result, pyridine-2-thione is released; the production of this byproduct (and therefore the progress of a reaction) can be measured spectrophotometrically at 343 nm. These reagents can be used as cross-linkers and to introduce sulfhydryl groups into proteins. The disulfide exchange can be performed at physiologic pH, although the reaction rate is slower than in acidic conditions.

DST is a homobifunctional cross-linker that contains amine-reactive N-hydroxysuccimide (NHS) ester groups and is periodate cleavable. DST is commonly used for conjugating radiolabeled ligands to cell surface receptors. DST must be first dissolved in an organic solvent, such as DMSO or DMF, then added to the aqueous reaction mixture. DST is lipophilic, membrane-permeable and does not possess a charged group, which makes it useful for intracellular and intramembrane protein conjugation.

Compositions were prepared with the following base components, each of which has a purpose in achieving the desired attributes: a) reversible cross-linkers of two types, hydrophobic and hydrophilic, to preserve membrane, cytoplasmic, and extracellular structures, b) low concentration of ethanol to minimize cell and tissue shrinkage, and c) kinase and phosphatase inhibitors to stabilize protein post-translational modifications. The tissue preservative composition for paraffin embedding contains an additional component, lactic acid, a carboxylic acid that retains water and maintains tissue cell nuclear volume and chromatin. The high concentration of lactic acid serves to decalcify bony tissue and calcium precipitates. The optimal embodiments of the compositions have been determined to preserve blood cells for flow cytometry, cytology, immunomagnetic separation, morphology, laser capture microdissection, and preservation of proteins, phosphoproteins, DNA and RNA. The optimal embodiments of the compositions have also been determined to preserve tissue cells for paraffin embedding, tissue morphology, immunohistochemistry, and genotyping. The preservative chemistry is suitable for one-step submersion of the tissue or blood in the composition with no requirement for operator training Tissue can be stored in the fixative for more than one month at 4 degrees Celsius prior to frozen sectioning or paraffin embedding with no apparent effect on morphology or immunohistochemistry antigen retention.

The preservative compositions have been evaluated for the following morphologic criteria: nuclear detail, membrane detail, overall contrast, color and cytoplasmic detail. Over a panel of 26 mouse and feline tissues (Table 1), the preservation, as judged by 3 independent board certified pathologists, was considered equal or superior to formalin for all tissues under these criteria (Table 2).

TABLE 1
Tissues evaluated for retention of histomorphology
post fixation in embodiment two of the invention,
with subsequent paraffin embedding.

Human
Breast
Uterus
Colon
Bone Marrow
Feline
Testis
Mouse
Skin
Bone
Bone Marrow
Ovary/Fallopian Tube
Pancreas
Spleen
Mouse
Brain
Eye
Ear (Cartilage)
Sublingual Gland
Heart
Mammary
Lung
Tongue
Stomach
Small Intestine
Colon
Ovary

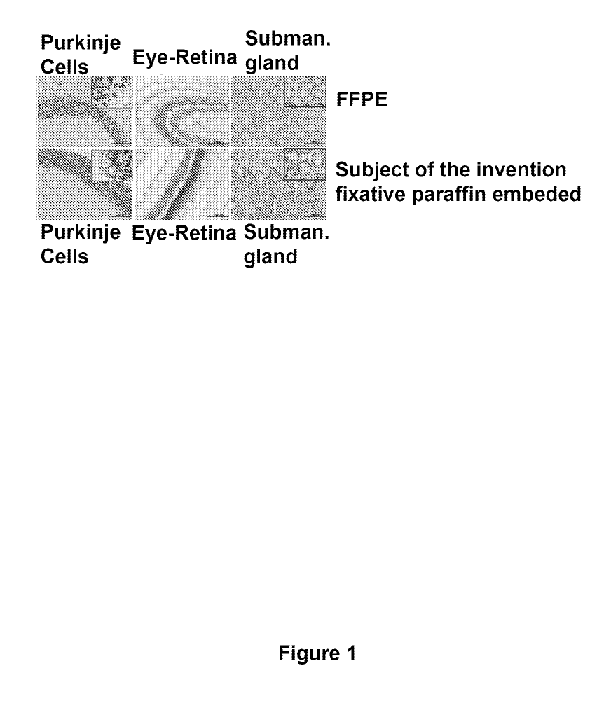

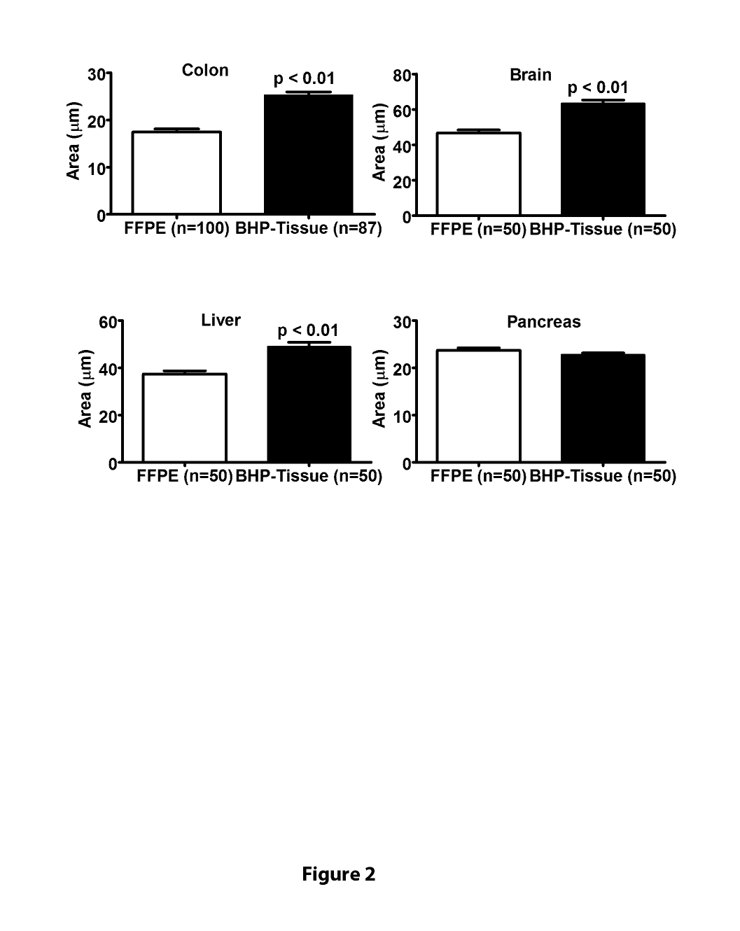

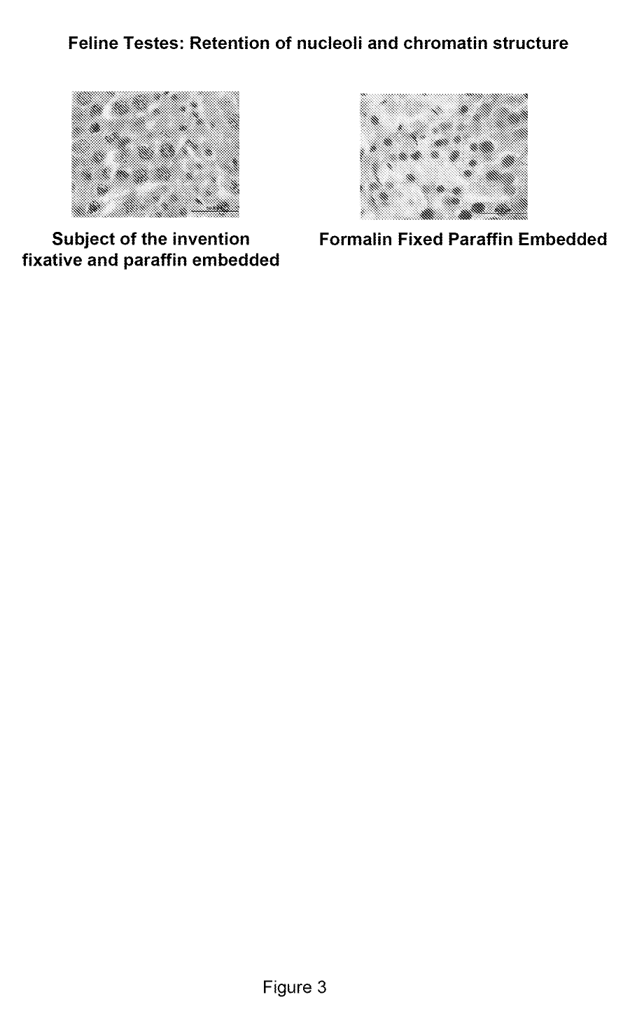

Examples are shown in FIG. 1. Preservation of nuclear volume is shown to be equal or superior to formalin in FIG. 2. The preservation of nuclear chromatin, nucleoli, chromosomes during meiosis and mitosis, and the nuclear membrane, was found to be superior to fixation chemistries known in the prior art for paraffin embedded 5 micron sections stained with hematoxylin and eosin (FIGS. 2 and 3).

Following fixation and paraffin embedding, all the immunohistochemistry antigens tested listed in Table 3 were found to be equal to or superior to formalin in preservation. In particular, the phosphoproteins tested were found to be superior to formalin for intensity of staining, with no increase in background staining

TABLE 2
Pathologist scoring of morphology for tissues
fixed in embodiment two of the invention.

| | | | |
|---|---|---|---|
| | Worse than | Equal to | Better than |
| Criteria | Formalin | Formalin | Formalin |

| | | |
|---|---|---|
| Overall color fidelity | Equal | |
| Cell size | Equal | |
| Preservation of | Equal | |
| nuclear membrane | | |
| Preservation of | | Better |
| nucleoli | | |
| Preservation of | Equal | |
| overall cell structure | | |
| Nuclear:Cytoplasmic | Equal | |
| ratio maintained | | |

TABLE 3
Antigens evaluated by immunohistochemistry in tissues
fixed in embodiment two of the invention.

| | | |
|---|---|---|
| Ki-67 (clone: MIB-1) | Cytokeratin 7 | Phospho-ERK |
| | | (Thr202/Tyr204) |
| Her2 | Cytokeratin 20 | Phospho-GSK3 αβ (Ser21/Ser9) |
| | (clone: Ks20.8) | |
| Estrogen Receptor α | CD3 | Phospho-eIF4G (Ser1108) |
| (clone: 1D5) | | |
| Progesterone Receptor | CD20 | Phospho-Akt (Ser473) |
| (clone: PgR 636) | | |
| Periodic Acid Schiff | CD31 | Phospho-p38 MAPK |
| (PAS) | | (Thr180/Tyr182) |
| Diastase PAS | CD34 | Phospho-Acetyl-CoA |
| | | Carboxylase (Ser79) |
| AE1AE3 | CD38 | Phospho-Bcl-2 (Ser70) |
| Smooth Muscle Actin | CD45 | |
| (clone: 1A4) | | |
| EGFR | CDX2 | |
| (clone: DAK-HI-WT) | | |

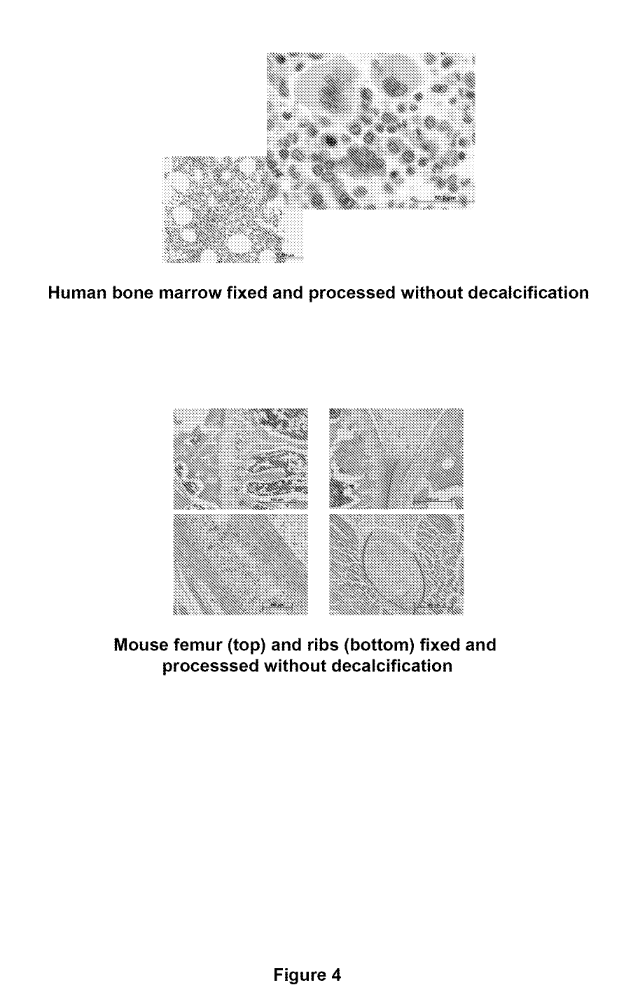

Due to the acid nature of the tissue chemistry embodiment, it has been found that bone decalcification rapidly occurs within at least 24 hours. This has been demonstrated in human bone marrow core biopsies (n=6) and mouse femur (FIG. 4). Full retention of histomorphology and cytomorphology is obtained with full paraffin sectioning fidelity.

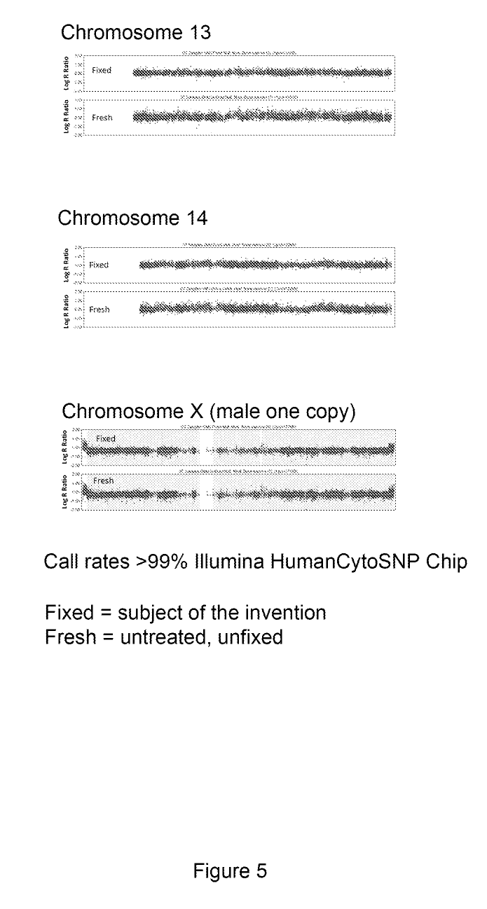

Bone marrow aspirates preserved in the subject invention can be immediately subjected to standard DNA isolation and used for high-resolution single nucleotide polymorphism (SNP) analysis. As shown in FIG. 5, a near perfect fidelity of SNP resolution and copy number amplitude is retained following preservation compared to the unfixed control. This is accomplished without extensive and tedious extraction protocols, resulting in a low yield, normally required for SNP analysis of fixed specimens.

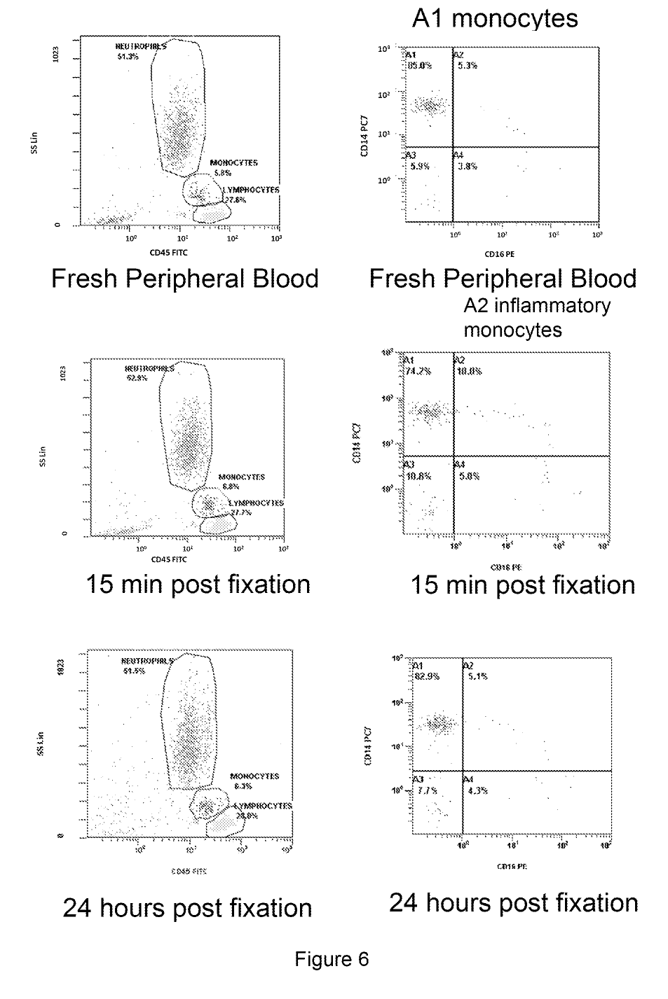

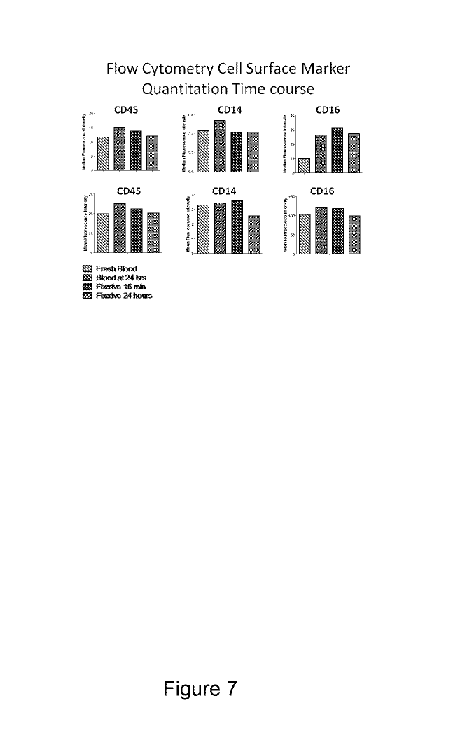

Preservation of blood cell antigenicity, morphology and flow cytometry by the subject invention was found to be equivalent to unfixed cells at one hour and 24 hours of fixation. We compared the hematologic cytology for a series of perturbations of the preservative chemistry. We scored a series of parameters for each blood cell subtype and found that the presence of the dual reversible/cleavable cross-linkers, with a low concentration of ethanol (less than 12%) achieved the optimum cytologic color, cytoplasm detail and nuclear detail. Flow cytometric cell sorting using the optimized formula demonstrated full flow compartmentalization of all immune cell subpopulations as shown in FIG. 6 with no loss of subpopulations compared to unfixed control, and full retention of surface antigen quantity over time (FIG. 7).

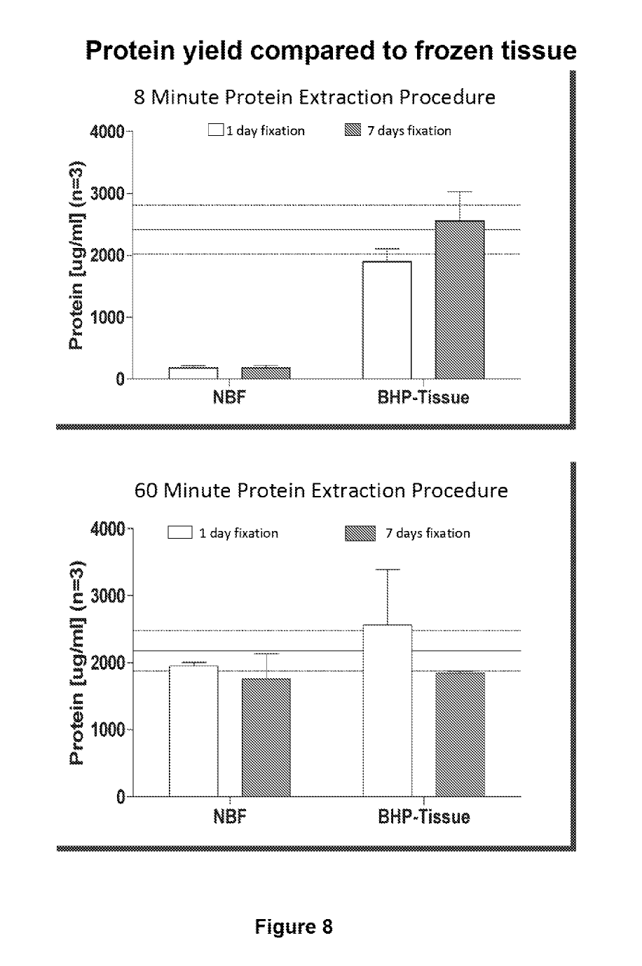

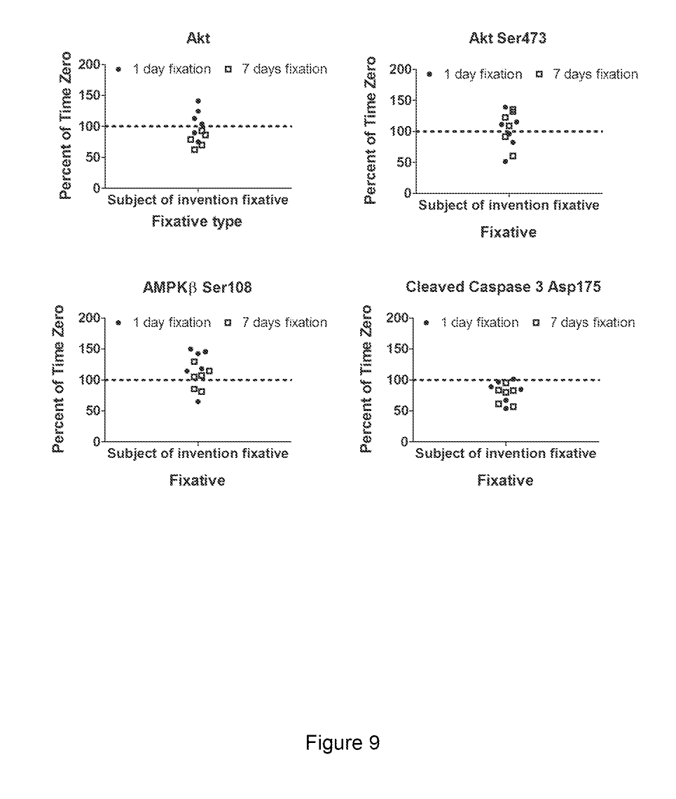

Molecular preservation of proteins was evaluated by immunohistochemistry, western blotting, reverse phase protein microarrays, and mass spectrometry. Table 4 lists the phosphoproteins analyzed using the subject invention. For all modalities the examined proteins were retained at least to the same quantitative degree as found in matched frozen tissue. As shown in FIG. 8, the extraction yield of total protein was equivalent to frozen tissue after less than 10 minutes of extraction. This is compared to hours or days required for protein extraction of alcohol fixed tissues or heavily cross-linked formalin fixed tissues. In FIG. 9, example preservation of phosphoprotein quantitative levels are shown for different regions of human colonic mucosa. The relative levels of phosphoproteins, as a ratio to actin, do not change over a seven day period. This demonstrates the one-step full preservation of phosphoprotein levels in the preservation chemistry prior to paraffin embedding of the tissue. Moreover no change of solutions is required prior to paraffin embedding under standard non-formalin based paraffin compositions and temperatures.

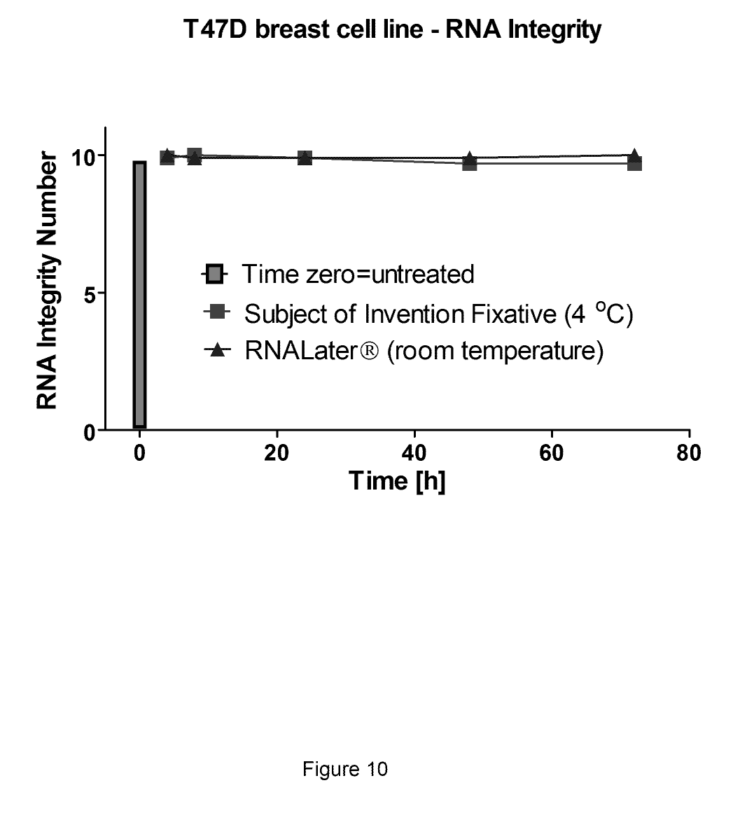

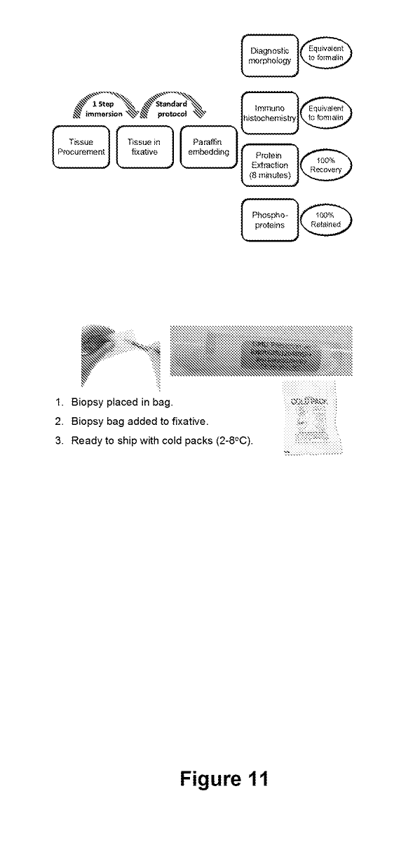

Preservation of RNA was evaluated by calculating the RNA integrity number (RIN) compared to matched preservation by RNAlater®. When stored at 4 degrees C. the RIN number was equivalent to RNAlater® and equivalent to time zero for up to 72 hours (FIG. 10). This demonstrates that the cells can be preserved for at least 72 hours at 4 degrees with adequate preservation of RNA prior to paraffin embedding. Thus the subject invention workflow is a one-step immersion of the cells or tissue in the fixative followed by direct downstream analysis for diagnostic morphology, immunhistochemistry, and biomolecule quantification (FIG. 11).

TABLE 4
Phosphoprotein analytes measured in frozen and/or paraffin
embedded tissue fixed in the subject invention chemistry.

| | | | | |
|---|---|---|---|---|
| 4E-BP1 (S65) | Chk1 (S345) | FKHRL1 (S253) | p38 MAP Kinase | Ras-GRF1 |
| | | | (T180/Y182) | (S916) |
| 4E-BP1 (T37/46) | Chk2 (S33/35) | FoxO1/O3(T24/32 | p53 (S15) | Ret (Y905) |
| 4E-BP1 (T70) | Cofilin (S3) | Gab1 (Y627) | p70 S6 Kinase | RSK3 |
| | (77G2) | | (S371) | (T356/S360) |
| 4G10 (anti | CREB (S133) | GSK-3alpha (S21) | p70 S6 Kinase | S6 Ribosomal |
| Phosphotyrosine) | | (46H12) | (T389) | Protein |
| | | | | (S235/236) |
| c-Abl (T735) | CrkII (Y221) | GSK-3alpha/beta | p70 S6 Kinase | S6 Ribosomal |
| | | (S21/9) | (T412) | Protein |
| | | | | (S240/244) |
| c-Abl (Y245) | CrkL (Y207) | GSK-3alpha | p90RSK (S380) | SAPK/JNK |
| | | (Y279)/beta | | (T183/Y185) |
| | | (Y216) | | |
| Acetyl-CoA | EGFR | Histone H3 (S10) | PAK1/2 | SEK1/MKK4 |
| Carboxylase | (S1046/1047) | Mitosis Marker | (S199/204/192/197) | (S80) |
| (S79) | | | | |
| Adducin (S662) | EGFR (Y845) | HSP27 (S82) | PARP, cleaved | Shc (Y317) |
| | | | (D214) | |
| AFX (S193) | EGFR (Y992) | HSP90a (T5/7) | Paxillin (Y118) | SHIP1 (Y1020) |
| Akt (S473) | EGFR (Y1045) | IGF-1 Rec | PDGF Receptor beta | Smad2 |
| | | (Y1131)/Insulin | (Y716) | (S465/467) |
| | | Rec (Y1146) | | |
| Akt (T308) | EGFR (Y1068) | IGF-1R | PDGF Receptor beta | Smad2 |
| | | (Y1135/36)/IR | (Y751) | (S245/250/255) |
| | | (Y1150/51) | | |
| ALK (Y1586) | EGFR (Y1148) | IkappaB-alpha | PDK1 (S241) | Src Family |
| | | (S32/36) (5A5) | | (Y416) |
| AMPKalpha1 | EGFR (Y1173) | IRS-1 (S612) | PKA C (T197) | Src (Y527) |
| (S485) | | | | |
| AMPKBeta1 | EGFR (Y1173) | Jak1 | PKC alpha (S657) | Stat1 (Y701) |
| (S108) | (53A3) | (Y1022/1023) | | |
| Arrestin1 (Beta) | eIF4E (S209) | c-Kit (Y703) | PKC alpha/beta II | Stat1 (Y701) |
| (S412) (6-24) | | (D12E12) | (T638/641) | |
| ASK1 (S83) | eIF4G (S1108) | c-Kit (Y719) | PKC (pan) (betaII | Stat2 (Y690) |
| | | | S660) | |
| ATF-2 (T71) | Elk-1 (S383) | Lamin A, cleaved | PKC delta (T505) | Stat3 (S727) |
| | | (D230) | | |
| ATF-2 (T69/71) | eNOS (S113) | Lck (Y505) | PKC theta (T538) | Stat3 (Y705) |
| | | | | (9E12) |
| Aurora A | eNOS (S1177) | LKB1 (S334) | PKC zeta/lambda | Stat3 (Y705) |
| (T288)/B(T232)/ | | | (T410/403) | (D3A7) |
| C (T198) | | | | |
| Bad (S112) | eNOS/NOS III | LKB1 (S428) | cPLA2 (S505) | Stat5 (Y694) |
| | (S116) | | | |
| Bad (S136) | ErbB2/HER2 | MAPK (pTEpY) | PLCgamma1 | Stat6 (Y641) |
| | (Y1248) | | (Y783) | |
| Bad (S155) | ErbB3/HER3 | MARCKS | PLK1 (T210) | Syk (Y525/526) |
| | (Y1289) (21D3) | (S152/156) | | |
| Bcl-2 (S70) | ERK 1/2 | MEK1/2 | PRAS40 (T246) | Tuberin/TSC2 |
| (5H2) | (T202/Y204) | (S217/221) | | (Y1571) |
| Bcl-2 (T56) | Estrogen | Met | PRK1 (T774)/PRK2 | Tyk2 |
| | Receptor alpha | (Y1234/1235) | (T816) | (Y1054/1055) |
| | (S118) | | | |
| Caspase-3, | Etk (Y40) | MSK1 (S360) | Progesterone | Vav3 (Y173) |
| cleaved (D175) | | | Receptor (S190) | |
| Caspase-6, | Ezrin (Y353) | Mst1 (T183)/Mst2 | PTEN (S380) | VEGFR 2 |
| cleaved (D162) | | (T180) | | (Y951) |
| Caspase-7, | Ezrin | mTOR (S2448) | Pyk2 (Y402) | VEGFR 2 |
| cleaved (D198) | (T567)/Radixin | | | (Y996) |
| | (T564)/Moesin | | | |
| | (T558) | | | |
| Caspase-9, | FADD (S194) | mTOR (S2481) | Raf (S259) | VEGFR 2 |
| cleaved (D315) | | | | (Y1175) |
| | | | | (19A10) |
| Caspase-9, | FAK (Y397) | NF-kappaB p65 | A-Raf (S299) | Zap-70 |
| cleaved (D330) | (18) | (S536) | | (Y319)/Syk |
| | | | | (Y352) |
| Catenin (beta) | FAK (Y576/577) | NPM (T199) | B-Raf (S445) | |
| (S33/37/T41) | | | | |
| Catenin (beta) | FKHR (S256) | p27 (T187) | c-Raf (S338) (56A6) | |
| (T41/S45) | | | | |

### Materials and Methods:

1. Protocol for making the blood cell fixative without lactic acid:

Prepare stock solutions of 10% polyethylene glycol (MW 8000) (Fisher), 100 mM sodium orthovanadate (Sigma), and 1.0M Beta Glycerophosphate (Calbiochem) in type 1 reagent grade water. Prepare a stock solution of 200 mM Genistein (Alexis Biochemicals) in DMSO.

Dissolve 0.05 mg DSP (Pierce) in 500 μL DMSO. Dissolve 0.05 mg DTBP in 500 μL Type 1 reagent grade water.

Add 6.0 mL of 200 proof ethanol (Sigma) to 38 mL of Hanks Balanced Salt Solution (Hyclone, Fisher).

Add 250 μL 10% polyethylene glycol, 1000 μL sodium orthovanadate (Sigma), 3.75 mL Beta Glycerophosphate (Calbiochem), 50.0 μL of 1.0 mM Staurosporine ready-to-use in DMSO (Sigma cat #S6942) and 2.5 μL Genistein (Alexis Biochemicals), 500 μL DSP solution, and 500 μL DTBP solution to the alcohol/Hanks Balanced Salt Solution. Mix gently.

2. Protocol for making tissue fixative with lactic acid for paraffin embedding:

Prepare stock solutions of 10% polyethylene glycol (MW 8000) (Fisher), 100 mM sodium orthovanadate (Sigma), and 1.0M Beta Glycerophosphate (Calbiochem) in type 1 reagent grade water. Prepare a stock solution of 200 mM Genistein (Alexis Biochemicals) in DMSO.

Dissolve 0.05 mg DSP (Pierce) in 2.5 mL DMSO. Dissolve 0.05 mg DTBP in 2.5 mL Type 1 reagent grade water.

Dissolve 5.0 g (L)+Lactic acid (Sigma) in 34 mL Hanks Balanced Salt Solution (Hyclone, Fisher).

Add 6.0 mL of 200 proof ethanol (Sigma) to the Hanks Balanced Salt/Lactic acid Solution.

Add 250 μL 10% polyethylene glycol, 1000 μL sodium orthovanadate (Sigma), 3.75 mL Beta Glycerophosphate (Calbiochem), 50.0 μL of 1.0 mM Staurosporine ready-to-use in DMSO (Sigma cat #S6942) and 5.0 μL Genistein (Sigma), 2.5 mL DSP solution, and 2.5 mL DTBP solution to the alcohol/Hanks Balanced Salt/Lactic acid solution. Mix gently.

3. Protocol for paraffin embedding:

Use ethanol processing steps. Do not use internal formalin fixation steps on the tissue processor. Program the tissue processor for the following steps: a) 70% ethanol, 45 minutes, 40° C., 0.5 bar vacuum, x2 cycles; b) 95% ethanol, 45 minutes, 40° C., 0.5 bar vacuum, x2 cycles; c) 100% ethanol, 30 minutes, 40° C., 0.5 bar vacuum; d) Xylene, 45 minutes, 40° C., 0.5 bar vacuum, x2 cycles; e) Paraplast paraffin, 60 minutes, 60° C., 0.5 bar vacuum; f) Paraplast paraffin, 90 minutes, 60° C., 0.5 bar vacuum, x4 cycles. Embed the tissue in paraffin blocks. Cut standard paraffin sections (5 μm) on charged or coated slides for immunohistochemistry or H&E staining Cut standard paraffin sections on plain, uncoated slides for laser capture microdissection.

4. Protocol for Dako autostainer immunohistochemistry:

Formalin fixed (FFPE) or embodiment 2 fixed paraffin embedded tissue sections (5 μm thickness) mounted on positively charged glass slides were baked at 56° C. for 30 min, deparaffinized in xylene and rehydrated in a series of graded alcohols (100%, 95%, and 70%) with a final rinse in wash buffer (Dako). Immunostaining post heat induced epitope retrieval was performed on a Dako Autostainer with an EnvisionSystem+HRP staining kit (Dako) with development in diaminobenzidine per manufacturer's instructions. Tissue sections were nuclear counterstained with hematoxylin (Dako) and Scott's Tap Water Substitute, and cover slips were applied with aqueous mounting medium (Faramount, Dako). Periodic Acid Schiff staining (Richard-Allan Scientific, Kalamazoo, MI) of FFPE and embodiment 2 fixed colon mucosa sections was performed per manufacturer's instructions. Images were captured with an Olympus BX51 microscope using 20× or 100× objectives.

5. Protocol for Illumina SNP analysis:

Nucleic acid preparations derived from human bone marrow aspirates collected in sodium heparin were tested using quantitative PCR (qPCR), PicoGreen (Invitrogen) staining and fluorometry (FLx800 fluorescence plate reader). An aliquot of the bone marrow was fixed in 2.5 volumes of the cell fixative chemistry (embodiment 1). An unfixed, matched aliquot was assayed as a control sample. Microarray-based genomic analysis was performed using CytoSNP-12 beadchips (Illumina, Inc.) and analyzed on an Illumina BeadStation 500 GX laser scanner [2-4]. DNA extraction and purification was performed using a DNA purification column (QIAmp DNA Mini Kit, Qiagen, Valencia, Calif.). Approximately 193 ng of DNA at a concentration of 50 ng/μL was amplified, fragmented, precipitated, re-suspended, and hybridized to the Illumina CytoSNP-12 beadchips. After single-base extension, sample DNA was stained and the chip was washed, dried, and scanned for the resulting 300,000 SNP calls and copy number values.

Raw fluorescence data was converted to genotypic data using the Illumina GenomeStudio software program. Data analysis was performed using the Illumina KaryoStudio software program that converts genotypic and signal intensity data into a “molecular karyotype” showing B allele frequency, Log R ratio, LOH score and Copy Number Score. Log R ratio, which is the log (base 2) ratio of the normalized R value for the particular SNP divided by the expected normalized R value, was employed. A Log R Ratio\2 was considered to represent a true amplification and Log R Ratio\-1.5 was considered to represent a probable homozygous deletion.

6. Protocol for processing for flow cytometry:

Five mL of peripheral blood was collected by venipuncture into EDTA tubes and processed within 20 minutes of collection. The immunophenotype was determined by flow cytometry, including light scatter (forward and side scatter) and fluorescence properties. All antibodies used (CD3, CD19, CD45, Immunotech, Marseille, France; mouse IgG1 antihuman monoclonal antibody (MRCOX-104, BDPharmingen, U.S.A.) were established for routine clinical practice use in our laboratory for the diagnosis of hematological malignancies. Briefly, 500 μL of each sample was fixed with 500 μL of the cell preservative chemistry for 15 minutes at room temperature, while the remainder was left at room temperature for an equal amount of time. Following incubation, samples were washed twice in 20 mL of phosphate buffer saline (PBS) +0.2% bovine serum albumin (BSA). White cell count concentration was adjusted to 5×10⁶/ml and 100 μL aliquots were stained with 10 μL monoclonal antibody for 15 min at room temperature. Erythrocytes were lysed with FACS Lyse (Becton Dickinson) according to manufacturer's conditions and cells were washed again with 0.2% BSA/PBS. Flow cytometric analysis was performed using a Cytomics FC500 (Beckman Coulter). The fluorescence intensity was measured according to Gong et al. [5], using a logarithmic scale with signal intensity ranging from 100 to 104. Lymphocytes were gated using CD45 fluorescence as well as side-scattering properties.

The optimal fixative chemistry for flow cytometry was verified by analyzing forward scatter, side scatter for cell size and morphology. Peripheral blood was collected in EDTA from a healthy male donor. Blood was added to equal volumes of the fixative solution and incubated at 4oC, for 15 min. Red blood cells were then lysed with ammonium chloride solution (150 mM Ammonium chloride (NH4Cl) 16.25 g; 10.0 mM Potassium bicarbonate (KHCO3) 2.0 g; EDTA 0.074 g, MilliQ water 2.0 L). A cell pellet was prepared by centrifugation at 400×g for 4 min. Fixative was removed, and the cell pellet was washed twice with 0.2% BSA/PBS. The cells were resuspended in BSA/PBS. For the detection of the immature myeloid cell subset, 50 μL of whole blood was labeled with monoclonal antibodies: anti-CD11b FITC, clone BEAR1, anti-CD14 PE, clone RMO52, anti-CD13 R-phycoerythrin-Cyanine 5 (PC5), clone Immul03.44, anti-CD34 R-phycoerythrin-Texas red (ECD), clone 581 after fixation and washing. Cells/antibody were incubated for 10 minutes during flow cytometer set-up.

For the detection of inflammatory monocytes CD14+CD16+, 50 μL, of whole blood was labeled with monoclonal antibodies: anti-CD 14 Phycoerythrin (PE), clone RMO52, and anti-CD16 Fluorescein isothiocyanate (FITC). All monoclonal antibodies were purchased from Immunotech, Beckman-Coulter (Marseille, France). Beta mercaptoethanol (10%), for reducing cross-links, was added immediately before running the flow and after adding the antibody. 10,000 cells were acquired.

7. Protocol and buffer for protein extraction from paraffin sections:
(A) Short protocol (protein yield: BHP-Tissue (embodiment 2) ˜100%; NBF (formalin) ˜10%)

Sections were deparaffinized in two changes of xylene for 15 minutes each, rehydrated in graded alcohols (100%, 95%, 70%) and air dried prior to protein extraction. Whole tissue sections were scraped off with a clean razor blade and added to extraction buffer consisting of a 10% (v/v) solution of Tris(2-carboxyethyl)phosphine (TCEP; Pierce, Rockford, Ill.) in Tissue Protein Extraction Reagent (T-PER™, Pierce)/2× SDS Tris-glycine buffer (Invitrogen, Carlsbad, Calif.). Protein lysates were incubated at 100° C. for 8 minutes. The volume of extraction buffer per each whole slide lysate was based on the area of each tissue section. The area was estimated by outlining a representative image of a serial section of each sample using a polygon drawing software option with the ArcturusXT laser capture microdissection instrument (Life Technologies, Carlsbad, Calif.) and calculating the resulting polygon area.

(3) Long protocol (protein yield: BHP-Tissue (embodiment 2) ˜100%; NBF(formalin) ˜100%)

Protein extraction was performed according to a protocol adapted from Ostasiewicz et al [1]. In short, sections were deparaffinized in two changes of xylene for 15 minutes each, rehydrated in graded alcohols (100%, 95%, 70%) and air dried prior to protein extraction. Whole tissue sections were scraped off with a clean razor blade and added to extraction buffer consisting of a 100 mM Tris-Hcl buffer (Bio-Rad, Hercules, Calif.) at pH 8, containing 100 mM dithiothreitol (DTT; Fisher Scientific) and 4% sodium dodecyl sulfate (SDS; Research Products International Corp., Mt. Prospect, Ill.). Protein lysates were incubated at 100° C. for 60 minutes and vortexed every 5 minutes. The volume of extraction buffer per each whole slide lysate was based on the area of each tissue section. The area was estimated by outlining a representative image of a serial section of each sample using a polygon drawing software option with the ArcturusXT laser capture microdissection instrument (Life Technologies, Carlsbad, Calif.) and calculating the resulting polygon area.

8. Protocol for conducting RNA analysis:

T47D cells were grown to confluence, media removed and flasks washed three times with 10 ml of cold PBS. Cells were scraped and spun for 5 minutes at 300 g and 4° C. After removal of PBS either RNAlater® (Ambion) or BHP-Cell was added to the cells and incubated at room temperature (RNAlater®) or 4° C. (BHP-Cell) up to 72 hours. To extract RNA from RNAlater® samples 1 ml of cold PBS was added to allow for the cells to be spun down at 5000 g for 5 minutes at room temperature. BHP-Cell samples were directly spun at 300 g for 5 minutes at room temperature. For time zero cells were immediately suspended in RLT buffer. The following RNA extraction was performed according to the RNeasy Mini Kit protocol (RNeasy Mini Kit, Qiagen GmbH, Germany).

9. Protocol for mass spectrometry:

Whole blood was collected from a healthy donor into two EDTA vacutainers. Blood from one tube was incubated for 4 hours at room temperature with an equal amount of BHP-Cell (embodiment 2), while the other tube was left at room temperature without addition of fixative. Samples were spun down (1000×g) and plasma/fixative was replaced with phosphate buffered saline (Gibco). Following, peripheral blood mononuclear cells (PBMC) were isolated using standard ficoll density separation protocols and frozen at −80° C. until further use. After thawing on ice, the samples (approximately 0.5 mg of protein) were reduced by 10 mM DTT in the presence of 8 M urea, alkylated by 50 mM iodoacetamide, and digested with trypsin. The digestion mixtures were desalted by a SepPak C18 column (Waters, catalog number: WAT054955) and tryptic peptides were purified from the mixtures. Phosphopeptides were then enriched from the purified peptides using a TiO2 column and identified by reversed-phase liquid chromatography coupled nanospray tandem mass spectrometry (LC-MS/MS) using an LTQ-Orbitrap mass spectrometer as described previously [6].

### REFERENCES

1. Espina V, Edmiston K H, Heiby M, Pierobon M, Sciro M, Merritt B, Banks S, Deng J, VanMeter A J, Geho D H, Pastore L, Sennesh J, Petricoin E F 3rd, Liotta L A. A portrait of tissue phosphoprotein stability in the clinical tissue procurement process. Mol Cell Proteomics. 2008 October; 7(10):1998-2018.
2. Mardis E R (2008) The impact of next-generation sequencing technology on genetics. Trends Genet 24: 133-141.
3. Smith D R, Quinlan A R, Peckham H E, Makowsky K, Tao W, et al (2008) Rapid whole-genome mutational profiling using next-generation sequencing technologies. Genome Res 18: 1638-1642.
4. Rao S K, Edwards J, Joshi A D, Siu I M, Riggins G J (2009) A survey of glioblastoma genomic amplifications and deletions. J Neurooncol.
5. Gong J Z, Lagoo A S, Peters D, Horvatinovich J, Benz P, et al. (2001) Value of CD23 determination by flow cytometry in differentiating mantle cell lymphoma from chronic lymphocytic leukemia/small lymphocytic lymphoma. Am. J. Clin. Pathol 116: 893-897.
6. Jawaid S, Seidle H, Zhou W, Abdirahman H, Abadeer M, et al. (2009) Kinetic characterization and phosphoregulation of the Francisella tularensis 1-deoxy-D-xylulose 5-phosphate reductoisomerase (MEP synthase). PLoS ONE 4: e8288.

All publications, including issued patents and published patent applications, and all database entries identified by url addresses or accession numbers are incorporated herein by reference in their entirety.

Although this invention has been described in relation to certain embodiments thereof, and many details have been set forth for purposes of illustration, it will be apparent to those skilled in the art that the invention is susceptible to additional embodiments and that certain of the details described herein may be varied considerably without departing from the basic principles of the invention.

1. A one-step chemical composition for preserving animal cells comprising:
a. a precipitating fixative,
b. a reversible/cleavable cross-linker,
c. a permeation enhancer,
d. a kinase inhibitor,
e. a phosphatase inhibitor, and
f. a carboxylic acid.

2. The composition of claim 1 further comprising an isotonic salt solution.

3. The composition of claim 1 wherein the precipitating fixative stabilizes the proteins in the sample and has a sufficient water content for a permeation enhancer, a kinase inhibitor, and/or a phosphatase inhibitor to be soluble therein.

4. The composition of claim 1 wherein the precipitating fixative is an alcohol.

5. (canceled)

6. (canceled)

7. The composition of claim 1 wherein the reversible/cleavable cross-linker is hydrophilic.

8. (canceled)

9. The composition of claim 1 wherein the reversible/cleavable cross-linker is hydrophobic.

10. (canceled)

11. The composition of claim 1 wherein the permeation enhancer comprises water, dimethylsulfoxide, polyethylene glycol, or propylene glycol.

12. The composition of claim 1 wherein the kinase inhibitor comprises staurosporine, genistein, small molecule inhibitors, antibodies, apatmers, or non-hydrolysable ATP.

13. (canceled)

14. The composition of claim 1 wherein the phosphatase inhibitor comprises sodium orthovanadate, beta glycerophosphate, sodium fluoride, or sodium molybdate.

15. (canceled)

16. The composition of claim 1 wherein the carboxylic acid is lactic acid.

17-21. (canceled)

22. The composition of claim 1 wherein the precipitating fixative comprises methanol or ethanol, the permeation enhancer comprises water, dimethylsulfoxide, or polyethylene glycol, the kinase inhibitor comprises staurosporine or genistein, the phosphatase inhibitor comprises sodium orthovanadate or beta glycerophosphate, the reversible/cleavable cross-linker comprises dimethyl 3,3′-dithiobispropionimidate2HCl or dithiobis[succinimidylpropionate], and the carboxylic acid comprises lactic acid.

23-29. (canceled)

30. A method for preserving a biological sample, comprising contacting the sample with the composition of claim 1 under conditions effective for the preservation of the sample.

31. The method of claim 30 wherein the composition stabilizes nucleic acids and chromatin in the sample.

32-34. (canceled)

35. The method of claim 30 wherein the composition preserves the morphology of cells in the sample.

36. (canceled)

37. The method of claim 30 wherein the composition stabilizes proteins, phosphoproteins, and protein posttranslational modifications in the sample.

38. (canceled)

39. The method of claim 30 wherein the composition preserves immunohistochemistry markers in the sample.

40. (canceled)

41. The method of claim 30, further comprising the step of analyzing the phosphorylation state of at least one phosphoprotein in the sample.

42. A one-step chemical composition for preserving animal cells comprising: a) a non-aldehyde precipitating fixative at a concentration below 25% (v/v), b) a reversible/cleavable cross-linker that targets lipid-associated molecules, and c) a reversible/cleavable cross-linker that targets water soluble molecules.

43-46. (canceled)

47. The composition of claim 42 further comprising a kinase inhibitor, a phosphatase inhibitor, and a permeation enhancer.

48-50. (canceled)

51. The composition of claim 42 further comprising a sufficient concentration of lactic acid to maintain cellular nuclear volume at a level equivalent to aldehyde fixation of the same type of tissue or cells.

52. The composition of claim 47 further comprising a sufficient concentration of lactic acid to maintain cellular morphology, nuclear volume, and nuclear chromatin at a level equivalent or superior to aldehyde fixation of tissue or cells and to maintain the antigenic preservation of nuclear, membrane, and cytoplasmic antigens equivalent to aldehyde fixation.

53-59. (canceled)

60. A method for preserving a biological sample, comprising contacting the sample with the composition of claim 42 any one of claims 1 59 under conditions effective for the preservation of the sample.

61-74. (canceled)

75. The composition of claim 1 comprising a reversible/cleavable cross-linker that targets lipid-associated molecules and a reversible/cleavable cross-linker that targets water soluble molecules.

76-79. (canceled)

80. A kit for collecting a biological sample for analysis comprising the composition of claim 1 and a container for transporting the sample.

81. (canceled)

82. The kit of claim 81 wherein the container comprises a vacuum evacuated collection tube.

83. A method for collecting a biological sample for analysis comprising the steps of a) immersing the sample in the composition of claim 1, b) transporting the immersed sample without freezing, and c) subjecting the sample to morphologic, imaging, or molecular analysis.

84. The method of claim 83 wherein the analysis provides a diagnostic determination or a treatment recommendation.

85. The method of claim 83 wherein the biological sample comprises whole blood.

86. (canceled)
